(19) United States
(12) Patent Application Publication
(10) Pub. No.: US 2015/0071613 A1
(43) Pub. Date: Mar. 12, 2015

(54) METHOD AND SYSTEM FOR INSERTING AND/OR MANIPULATING DYNAMIC CONTENT FOR DIGITAL MEDIA POST PRODUCTION

(71) Applicant: In Situ Media Corporation, Vancouver (CA)

(72) Inventors: Fatehali T. Dharssi, Vancouver (CA); Ashley McKay, Vancouver (CA)

(73) Assignee: In Situ Media Corporation, Vancouver, BC (CA)

(21) Appl. No.: 14/394,263

(22) PCT Filed: Apr. 15, 2013
(86) PCT No.: PCT/CA2013/000355

§ 371 Date: Oct. 13, 2014

Related U.S. Application Data
(60) Provisional application No. 61/624,174, filed on Apr. 13, 2012.

(51) Int. Cl. G11B 27/031; G06T 11/60; H04N 5/272; H04N 21/81; H04N 21/85; G06Q 30/02; G11B 27/28

(52) U.S. Cl. CPC G11B 27/031; G06Q 30/0241; G06T 11/60; G11B 27/28; H04N 21/812; H04N 21/85; H04N 5/272
USPC 386/278

(57) ABSTRACT

A method of inserting a new image into a dynamic digital video file comprises identifying a target digital video segment into which the new image is to be inserted, projectively transforming the digital video segment from a first state to a second state, the second state being one which defines a substantially undistorted background, primed for new image insertion, and wherein any feature differences as between the first state and the second state are adjustment features; recording segment into data related to the adjustment features; selecting a point of insertion of new image; and blending the new image with the second state of the target digital video segment, weighing the adjustment features against each such that any visual cues which would mark placement of the new images as incongruous are adjusted.

### FIELD OF THE INVENTION

This invention relates to the field of digital image manipulation and the wide variety of contexts in which such manipulation is desirable.

### BACKGROUND OF THE INVENTION

Digital cinema or digital media creation is the process of capturing moving pictures as digital images, rather than on film. Digital capture may occur on video tape, hard disks, flash memory, or other media which can record digital data. As digital technology has improved over the years, this practice has become increasingly common and in fact many television shows and feature films are now shot partially or fully in digital format.

With the prevalence of these videos, it is considered desirable and useful to be able to manipulate digital images after creation/production. There are various reasons for this. Realistic content modification can change a scene context, offer product placement, offer advertising and adapt content aesthetics based on user preferences.

Specifically with regard to digital product placement, there is a huge demand for replacement of products or insertion de novo of products into appropriate scenes. Since the inception of TiVo in 1997, digital video recorders (DVRs) have quickly become a staple in many households. One significant reason consumers prefer this technology is because it gives them the ability to skip commercials that appeared in a show's original broadcast. Complementing this trend, viewers can now watch many of their favorite television shows online or, in the alternative, download commercial-free episodes onto their computers or portable media players (e.g., iPods or even cell phones) for a small charge.¹ This mode of viewing shows no signs of slowing. ¹ See, for example Apple-iTunes, http:/lwww.apple.com/itunes/store/tvshowshtml (providing instructions on how to download TV shows onto iTunes, for viewing on a computer, or uploading onto a portable media device such as an iPod)

Such digital advances do not solely impact television viewers. Due to the increased use of this commercial-skipping technology, advertisers have had to find new ways beyond the traditional thirty-second commercial to get their messages out. Strategic product placement has been a welcome replacement. A market research firm found that the value of television product placement jumped 46.4% to $1.87 billion in 2004, and predicted (correctly) that the trend will likely continue due to the “growing use of [DVRs] and larger placement deals as marketers move from traditional advertising to alternative media.² ² See Johannes, TV Placements Overtake Film, supra note 15 (quoting a marketing association president as saying “product placement is the biggest thing to hit the advertising industry in years,” and noting that PQ Media predicts the value of product placement will grow at a compound rate of 14.9% to reach $6.94 billion by 2009).

Although product placement has been around in some form for years, the new focus on merchandising is via digital product placement or replacement. Digital product placement occurs when advertisers insert images of products into video files after they have already been created. For example, such technology has been used for years to superimpose a yellow first-down line into football broadcasts or to insert product logos behind home plate during televised baseball games.³ See Wayne Friedman, Virtual Placement Gets Second Chance, ADVERTISING AGE, Feb. 14, 2005, at 67 (discussing efforts to incorporate digital product placement into television).

Current methods used to modify images in digital production video include:

Computer graphics alpha compositing: this method⁴ uses weighted pixel color alteration to combine images by creating the appearance of translucency. These methods focus on blending of colors, but cannot effectively make a seamless image. Generally, the matte used in systems based on this method will create visual aberrations in lighting, textures, or color. Therefore, additional manual adjustment is necessary to prevent the viewer noticing that the video has post-production content or alterations. Generally, alpha compositing allows for soft translucent edges when selecting images. There are a number of ways to silhouette an image with soft edges including selecting the image or its background by sampling similar colors, selecting the edges by raster tracing, or converting a clipping path to a raster selection. Once the image is selected, it may be copied and pasted into another section of the same file, or into a separate file. The selection may also be saved in what is known as an alpha channel. At the basic level, compositing describes how shapes interact while blending describes how colors interact. Both idioms use a rendered version of a current element (i.e. a shape or a group) and mix it with the backdrop. ⁴ Porter, Thomas; Tom Duff (1984). “Compositing Digital Images”. Computer Graphics 18 (3): 253-259. doi:10.1145/800031.808606. ISBN 0897911385

Super-imposing video: video overlay compositing techniques typically add super imposed content on the original video. However, this method essentially requires two videos to run simultaneously to avoid desynchronizing. Therefore a video and super imposed new content require perfect timing during playback. Correct timing can be difficult to achieve when videos have differing download rates, buffering success, and format frame-rates etc. Thus, mismatched latencies in the aforementioned areas will cause a viewer to perceive visual aberrations in the post production appearance.

It is an object of the present invention to obviate or mitigate the above disadvantages such that digital images can be readily and dynamically manipulated.

### SUMMARY OF THE INVENTION

The present invention provides a method for mixing additional or modified content into an existing digital video. By way of such a method, one can realistically modify content, change scene context, offer product placement and other type of advertising, and adapt content aesthetics based on viewer preferences.

The present invention provides, in a further aspect, a method of inserting a new image into a dynamic digital video file which comprises:
a) identifying a target digital video segment into which the new image is to be inserted;
b) projectively transforming the digital video segment from a first state to a second state, the second state being one which defines a substantially undistorted background, primed for new image insertion, and wherein any feature differences as between the first state and the second state are adjustment features;
c) recording data related to the adjustment features;
d) selecting a point of insertion of new image; and
e) blending the new image with the second state of the target digital video segment, weighing the adjustment features against each such that any visual cues which would mark placement of the new images as incongruous are adjusted.

The present invention provides, in yet a further aspect, a method of manipulating an existing image into a dynamic digital video file which comprises:
a) identifying a target digital video segment comprising existing image;
b) projectively transforming the digital video segment from a first state to a second state, the second state being one which defines a substantially undistorted background, primed for image manipulation, and wherein any feature differences as between the first state and the second state are adjustment features;
c) recording data related to the adjustment features;
d) selecting a point of manipulation of existing image; and
e) blending the new image with the existing image, weighing the adjustment features against each such that any visual cues which would mark placement of the new images as incongruous are adjusted.

The present invention provides, in another aspect, a computer implemented method of inserting a new image into a dynamic digital video file which comprises:
a) identifying a target digital video segment into which the new image is to be inserted;
b) projectively transforming the digital video segment from a first state to a second state, the second state being one which defines a substantially undistorted background, primed for new image insertion, and wherein any feature differences as between the first state and the second state are adjustment features;
c) recording data related to the adjustment features;
d) selecting a point of insertion of new image; and
e) blending the new image with the second state of the target digital video segment, weighing the adjustment features against each such that any visual cues which would mark placement of the new images as incongruous are adjusted.

The present invention provides, in yet a further aspect, a computer implemented method of manipulating an existing image into a dynamic digital video file which comprises:
a) identifying a target digital video segment comprising existing image;
b) projectively transforming the digital video segment from a first state to a second state, the second state being one which defines a substantially undistorted background, primed for image manipulation, and wherein any feature differences as between the first state and the second state are adjustment features;
c) recording data related to the adjustment features;
d) selecting a point of manipulation of existing image; and
e) blending the new image with the existing image, weighing the adjustment features against each such that any visual cues which would mark placement of the new images as incongruous are adjusted.

The present invention provides, in another aspect, a non-transitory processor readable medium storing code representing instructions to cause a processor to insert a new image into a dynamic digital video file, said insert comprising:
a) identifying a target digital video segment into which the new image is to be inserted;
b) projectively transforming the digital video segment from a first state to a second state, the second state being one which defines a substantially undistorted background, primed for new image insertion, and wherein any feature differences as between the first state and the second state are adjustment features;
c) recording data related to the adjustment features;
d) selecting a point of insertion of new image; and
e) blending the new image with the second state of the target digital video segment, weighing the adjustment features against each such that any visual cues which would mark placement of the new images as incongruous are adjusted.

The present invention provides, in another aspect, a non-transitory processor readable medium storing code representing instructions to cause a processor to method of manipulating an existing image into a dynamic digital video file, said manipulation comprising:
a) identifying a target digital video segment comprising existing image;
b) projectively transforming the digital video segment from a first state to a second state, the second state being one which defines a substantially undistorted background, primed for image manipulation, and wherein any feature differences as between the first state and the second state are adjustment features;
C) recording data related to the adjustment features;
d) selecting a point of manipulation of existing image; and
e) blending the new image with the existing image, weighing the adjustment features against each such that any visual cues which would mark placement of the new images as incongruous are adjusted.

The present invention further provides, in another aspect, a system for altering an image of a product within a digital video file is provided, including: a) a first computer for requesting the digital video file from a second computer over a network; b) at least one of the first or second computers configured to: a) identifying a target digital video segment into which the new image is to be inserted; b) projectively transform the digital video segment from a first state to a second state, the second state being one which defines a substantially undistorted background, primed for new image insertion, and wherein any feature differences as between the first state and the second state are adjustment features; c) record data related to the adjustment features; d) select a point of insertion of new image; and e) blend the new image with the second state of the target digital video segment, weighing the adjustment features against each such that any visual cues which would mark placement of the new images as incongruous are adjusted.

The present invention further provides, in yet another aspect a system for placing virtual products within a moving media of digital video, motion picture or television content, comprising: an original moving media content source including a removable content, the removable content providing a virtual product location at a position in the moving media; a network in communication with the original moving media content source, the network providing a virtual product source; and a virtual product disposed within the virtual product source, the virtual product being an image of an item enabled for placement in the virtual product location of the removable content, the virtual product being enabled for updating the position of the virtual product location of the removable content in the moving media, wherein the virtual product is downloaded from the network, and placed on the moving media in the virtual product location; and wherein the virtual product is updated on the moving media in the virtual product location, by means of the following steps:
a) projectively transforming a segment of the moving media from a first state to a second state, the second state being one which defines a substantially undistorted background, primed for new product insertion, and wherein any feature differences as between the first state and the second state are adjustment features;
b) recording data related to the adjustment features;
c) selecting a point of insertion of new product; and
d) blending the new product with the second state of the segment of the moving media, weighing the adjustment features against each such that any visual cues which would mark placement of the new product as incongruous are adjusted.

One advantage of using the methods of the present invention is the assurance of consistent image changes occurring across a background. For example, the blending of two differently oriented background and content color gradients would ensure the perceived blending ratio of each pixel position would closely match the scene structure. Thus, the surface color of new content would more closely match the original images context, and, importantly, a viewer is less likely to detect the modified areas. Similarly, the correct patterns of light and shadow are preserved more accurately, and as such new composited content can preserve texture information normally lost in traditional methods that ignore the inferred scene structure.

Unlike any methods known in the art, this method is highly flexible as to advertiser requirements, in differing contexts. It readily enables an inserted image to be calibrated to the needs of an advertiser whereby the new image may required to be completely in the background and appear to be part of the original video for very passive advertising. In the alternative, an advertiser may require some features to be noticeable whereby the inserted image still appears to be in the background but some aspects of it may be emphasized, highlighted or otherwise changed for this to be noticeable to a viewer. In other words, there can be 100% tailoring to the advertiser's needs in regards to altering or modifying or adding or removing an image.

### BRIEF DESCRIPTION OF THE FIGURES

FIG. 1 is a graphical illustration of a pane showing how blur often preserves dominant features of a two dimensional picture;

FIG. 2 is a graphical illustration of a pane showing how additional graphical items are blended into the surface and appear consistent with the planes appearance by incorporating similar patterns, perceived color, and lighting changes and wherein all and particularly the details are preserved further along an inferred surface that would otherwise be lost; and

FIG. 3 is a flow chart showing the steps of modifying an image in a digital video file post-production.

The figures depict an embodiment of the present invention for purposes of illustration only. One skilled in the art will readily recognize from the following description that alternative embodiments of the structures and methods illustrated herein may be employed without departing from the principles of the invention described herein.

### DETAILED DESCRIPTION OF THE INVENTION

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

The algorithms and displays with the applications described herein are not inherently related to any particular computer or other apparatus. Various general-purpose systems may be used with programs in accordance with the teachings herein, or it may prove convenient to construct more specialized apparatus to perform the required machine-implemented method operations. The required structure for a variety of these systems will appear from the description below. In addition, embodiments of the present invention are not described with reference to any particular programming language. It will be appreciated that a variety of programming languages may be used to implement the teachings of embodiments of the invention as described herein.

An embodiment of the invention may be implemented as a method or as a machine readable non-transitory storage medium that stores executable instructions that, when executed by a data processing system, causes the system to perform a method. An apparatus, such as a data processing system, can also be an embodiment of the invention. Other features of the present invention will be apparent from the accompanying drawings and from the detailed description which follows.

### I Terms

The term “invention” and the like mean “the one or more inventions disclosed in this application”, unless expressly specified otherwise.

The terms “an aspect”, “an embodiment”, “embodiment”, “embodiments”, “the embodiment”, “the embodiments”, “one or more embodiments”, “some embodiments”, “certain embodiments”, “one embodiment”, “another embodiment” and the like mean “one or more (but not all) embodiments of the disclosed invention(s)”, unless expressly specified otherwise.

The term “variation” of an invention means an embodiment of the invention, unless expressly specified otherwise.

A reference to “another embodiment” or “another aspect” in describing an embodiment does not imply that the referenced embodiment is mutually exclusive with another embodiment (e.g., an embodiment described before the referenced embodiment), unless expressly specified otherwise.

The terms “including”, “comprising” and variations thereof mean “including but not limited to”, unless expressly specified otherwise.

The terms “a”, “an” and “the” mean “one or more”, unless expressly specified otherwise.

The term “plurality” means “two or more”, unless expressly specified otherwise.

The term “herein” means “in the present application, including anything which may be incorporated by reference”, unless expressly specified otherwise.

The terms “video” and “video file” and “digital video media” as used herein” will be afforded a broad and expansive meaning and cover, for example, media in all format(s) which are capable of being electronically conveyed. These include, but are not limited to digital video files and the like. The term “whereby” is used herein only to precede a clause or other set of words that express only the intended result, objective or consequence of something that is previously and explicitly recited. Thus, when the term “whereby” is used in a claim, the clause or other words that the term “whereby” modifies do not establish specific further limitations of the claim or otherwise restricts the meaning or scope of the claim.

The term “post-production” is intended to have broad meaning and refers to insertion of an image in a video or manipulation of an image in a video at any stage whatsoever after production of that video. It is to be understood that there are a plurality of opportunities, along a communication route or transmission channel for a video (from source to viewer) that the insertion and/or manipulation methods of the present invention may be applied. For example: on a computer or server of the video source or an a computer or server of the video viewer or on any one of a plurality of network computers and servers (cloud or non-cloud) there between (between source of viewer). An illustration of this is the conveyance of videos via the website YouTube® wherein, upon request, YouTube® sends to a viewer packets of data which is later reassembled for viewing on the viewer's computer. If viewer A requests a video clip from YouTube and is the first user to do so within a his/her network (for example Shaw®-internet provider), Shaw may choose to cache the video on one of its servers in anticipation of other viewers (say, B, C and D) within the same network as A eventually wishing to view the same video. In this illustration, the video may be manipulated at the source, while cached within the Shaw network or on the user's computer or anywhere in between.

The term “real time” refers to insertion of an image or manipulation of an image in a video at the same speed by which (and at the same time that) the video is communicated, relayed or transmitted to a viewer or intermediary. This contrasts with “non-real time” in which insertion of an image or manipulation of an image in a video is at a lower speed (and takes a greater time) than the time by which the video is communicated, relayed or transmitted. An example of non-real time is off-line insertion or manipulation.

The term “e.g.” and like terms mean “for example”, and thus does not limit the term or phrase it explains. For example, in a sentence “the computer sends data (e.g., instructions, a data structure) over the Internet”, the term “e.g.” explains that “instructions” are an example of “data” that the computer may send over the Internet, and also explains that “a data structure” is an example of “data” that the computer may send over the Internet. However, both “instructions” and “a data structure” are merely examples of “data”, and other things besides “instructions” and “a data structure” can be “data”.

The term “respective” and like terms mean “taken individually”. Thus if two or more things have “respective” characteristics, then each such thing has its own characteristic, and these characteristics can be different from each other but need not be. For example, the phrase “each of two machines has a respective function” means that the first such machine has a function and the second such machine has a function as well. The function of the first machine may or may not be the same as the function of the second machine.

The term “i.e.” and like terms mean “that is”, and thus limits the term or phrase it explains. For example, in the sentence “the computer sends data (i.e., instructions) over the Internet”, the term “i.e.” explains that “instructions” are the “data” that the computer sends over the Internet.

Any given numerical range shall include whole and fractions of numbers within the range. For example, the range “1 to 10” shall be interpreted to specifically include whole numbers between 1 and 10 (e.g., 1, 2, 3, 4, . . . 9) and non-whole numbers (e.g. 1.1, 1.2, . . . 1.9).

Where two or more terms or phrases are synonymous (e.g., because of an explicit statement that the terms or phrases are synonymous), instances of one such term/phrase does not mean instances of another such term/phrase must have a different meaning. For example, where a statement renders the meaning of “including” to be synonymous with “including but not limited to”, the mere usage of the phrase “including but not limited to” does not mean that the term “including” means something other than “including but not limited to”.

Neither the Title (set forth at the beginning of the first page of the present application) nor the Abstract (set forth at the end of the present application) is to be taken as limiting in any way as the scope of the disclosed invention(s). An Abstract has been included in this application merely because an Abstract of not more than 150 words is required under 37 C.F.R. section 1.72(b). The title of the present application and headings of sections provided in the present application are for convenience only, and are not to be taken as limiting the disclosure in any way.

Numerous embodiments are described in the present application, and are presented for illustrative purposes only. The described embodiments are not, and are not intended to be, limiting in any sense. The presently disclosed invention(s) are widely applicable to numerous embodiments, as is readily apparent from the disclosure. One of ordinary skill in the art will recognize that the disclosed invention(s) may be practiced with various modifications and alterations, such as structural and logical modifications. Although particular features of the disclosed invention(s) may be described with reference to one or more particular embodiments and/or drawings, it should be understood that such features are not limited to usage in the one or more particular embodiments or drawings with reference to which they are described, unless expressly specified otherwise.

No embodiment of method steps or product elements described in the present application constitutes the invention claimed herein, or is essential to the invention claimed herein, or is coextensive with the invention claimed herein, except where it is either expressly stated to be so in this specification or expressly recited in a claim.

The invention can be implemented in numerous ways, including as a process, an apparatus, a system, a computer readable medium such as a computer readable storage medium or a computer network wherein program instructions are sent over optical or communication links. In this specification, these implementations, or any other form that the invention may take, may be referred to as systems or techniques. A component such as a processor or a memory described as being configured to perform a task includes both a general component that is temporarily configured to perform the task at a given time or a specific component that is manufactured to perform the task. In general, the order of the steps of disclosed processes may be altered within the scope of the invention.

The following discussion provides a brief and general description of a suitable computing environment in which various embodiments of the system may be implemented. Although not required, embodiments will be described in the general context of computer-executable instructions, such as program applications, modules, objects or macros being executed by a computer. Those skilled in the relevant art will appreciate that the invention can be practiced with other computer configurations, including hand-held devices, multiprocessor systems, microprocessor-based or programmable consumer electronics, personal computers (“PCs”), network PCs, mini-computers, mainframe computers, and the like. The embodiments can be practiced in distributed computing environments where tasks or modules are performed by remote processing devices, which are linked through a communications network. In a distributed computing environment, program modules may be located in both local and remote memory storage devices.

A computer system may be used as a server including one or more processing units, system memories, and system buses that couple various system components including system memory to a processing unit. Computers will at times be referred to in the singular herein, but this is not intended to limit the application to a single computing system since in typical embodiments, there will be more than one computing system or other device involved. Other computer systems may be employed, such as conventional and personal computers, where the size or scale of the system allows. The processing unit may be any logic processing unit, such as one or more central processing units (“CPUs”), digital signal processors (“DSPs”), application-specific integrated circuits (“ASICs”), etc. Unless described otherwise, the construction and operation of the various components are of conventional design. As a result, such components need not be described in further detail herein, as they will be understood by those skilled in the relevant art.

A computer system includes a bus, and can employ any known bus structures or architectures, including a memory bus with memory controller, a peripheral bus, and a local bus. The computer system memory may include read-only memory (“ROM”) and random access memory (“RAM”). A basic input/output system (“BIOS”), which can form part of the ROM, contains basic routines that help transfer information between elements within the computing system, such as during startup.

The computer system also includes non-volatile memory. The non-volatile memory may take a variety of forms, for example a hard disk drive for reading from and writing to a hard disk, and an optical disk drive and a magnetic disk drive for reading from and writing to removable optical disks and magnetic disks, respectively. The optical disk can be a CD-ROM, while the magnetic disk can be a magnetic floppy disk or diskette. The hard disk drive, optical disk drive and magnetic disk drive communicate with the processing unit via the system bus. The hard disk drive, optical disk drive and magnetic disk drive may include appropriate interfaces or controllers coupled between such drives and the system bus, as is known by those skilled in the relevant art. The drives, and their associated computer-readable media, provide non-volatile storage of computer readable instructions, data structures, program modules and other data for the computing system. Although a computing system may employ hard disks, optical disks and/or magnetic disks, those skilled in the relevant art will appreciate that other types of non-volatile computer-readable media that can store data accessible by a computer system may be employed, such a magnetic cassettes, flash memory cards, digital video disks (“DVD”), Bernoulli cartridges, RAMs, ROMs, smart cards, etc.

Various program modules or application programs and/or data can be stored in the computer memory. For example, the system memory may store an operating system, end user application interfaces, server applications, and one or more application program interfaces (“APIs”).

The computer system memory also includes one or more networking applications, for example a Web server application and/or Web client or browser application for permitting the computer to exchange data with sources via the Internet, corporate Intranets, or other networks as described below, as well as with other server applications on server computers such as those further discussed below. The networking application in the preferred embodiment is markup language based, such as hypertext markup language (“HTML”), extensible markup language (“XML”) or wireless markup language (“WML”), and operates with markup languages that use syntactically delimited characters added to the data of a document to represent the structure of the document. A number of Web server applications and Web client or browser applications are commercially available, such those available from Mozilla and Microsoft.

The operating system and various applications/modules and/or data can be stored on the hard disk of the hard disk drive, the optical disk of the optical disk drive and/or the magnetic disk of the magnetic disk drive.

A computer system can operate in a networked environment using logical connections to one or more client computers and/or one or more database systems, such as one or more remote computers or networks. A computer may be logically connected to one or more client computers and/or database systems under any known method of permitting computers to communicate, for example through a network such as a local area network (“LAN”) and/or a wide area network (“WAN”) including, for example, the Internet. Such networking environments are well known including wired and wireless enterprise-wide computer networks, intranets, extranets, and the Internet. Other embodiments include other types of communication networks such as telecommunications networks, cellular networks, paging networks, and other mobile networks. The information sent or received via the communications channel may, or may not be encrypted. When used in a LAN networking environment, a computer is connected to the LAN through an adapter or network interface card (communicatively linked to the system bus). When used in a WAN networking environment, a computer may include an interface and modem or other device, such as a network interface card, for establishing communications over the WAN/Internet.

In a networked environment, program modules, application programs, or data, or portions thereof, can be stored in a computer for provision to the networked computers. In one embodiment, the computer is communicatively linked through a network with TCP/IP middle layer network protocols; however, other similar network protocol layers are used in other embodiments, such as user datagram protocol (“UDP”). Those skilled in the relevant art will readily recognize that these network connections are only some examples of establishing communications links between computers, and other links may be used, including wireless links.

While in most instances a computer will operate automatically, where an end user application interface is provided, a user can enter commands and information into the computer through a user application interface including input devices, such as a keyboard, and a pointing device, such as a mouse. Other input devices can include a microphone, joystick, scanner, etc. These and other input devices are connected to the processing unit through the user application interface, such as a serial port interface that couples to the system bus, although other interfaces, such as a parallel port, a game port, or a wireless interface, or a universal serial bus (“USB”) can be used. A monitor or other display device is coupled to the bus via a video interface, such as a video adapter (not shown). The computer can include other output devices, such as speakers, printers, etc.

### II Preferred Aspects

The present invention provides a method to modify one or more frames in digital video, 3D video, 2D plus depth video, pictures or other types of video and images. When the term “image” is used herein, it is intended to encompass any or all of these. This invention is preferably practiced on a computer network whereby such alterations to video images are made at a server before a viewer requests downloading (on the Internet or another computer network) of a video for viewing.

It is to be understood that there are a number of known methods of actually identifying an image to be manipulated, or identifying the environment into which an image is to be inserted and any one of such methods can be fully practiced with the image modification method as described herein. Examples of such image identification technology can be found in the following patent publications: WO/2011/134073, WO2011/082476, US2011/0170772 and US2011/0267538, all of which are incorporated herein by reference. To be clear, of the two steps: 1) image identification and 2) image modification, the latter is the primary focus of the present invention.

Within the scope of the present invention image alterations are preferably made either at the server where the original video is stored, at the computer or device that the viewer is using to view the requested video, at an intermediate point or at multiple points/computer processors in such a network. Such alterations may also be made, at the same time or at different times, not only in one process but in multiple sub-processes in multiple computing devices in such a network. Such video may be viewed on a
mobile device like a Smartphone or tablet,
on a laptop, a desktop computer, or another type of a computer display device
on a TV screen which has some device like a cable set-top box, a programmable video recorder (PVR) or modem, to enable data and/or video communication, and/or software execution.

Such a video may be altered for reasons such as advertising (placement, removal or replacement of posters, product images, pictures, or other such items to advertise a product in a video scene) placement of a product image in such a video. This may be at the request of an advertiser or a video producer. One primary purpose for altering the image at the point of downloading is to enable advertising or product placement to be targeted to viewers based on a viewer's Internet and product purchase data. As an example, if a viewer is a regular diet Coke user (as evident for purchase data of such viewer obtained from supermarket scanners) or Facebook data shows that the viewer has recently started a fitness program, then an advertiser may wish to place a can or a package of diet Pepsi in an appropriate scene in a video being viewed by such a viewer. This would also include removing any conflicting or competing products that are shown in the original video.

In one aspect, the method of the invention uses metrics of/data relating toexisting video to infer how it would normally appear to human viewers. The method strategically modifies content to exploit optical illusions created by human perceptual bias. Statistical data about several perceptual factors ensure modified video content is not normally perceptible to a viewer. Typically, the optical illusion methods exploit common bias in perception for depth, motion, scale, color, brightness, and optical consistency.

Additionally, this method seamlessly inserts or removes advertising or other content into existing video content by using adaptive texture transformations, traditional alpha channel blending, and matte blending with structured edge interpolation. For example, a TV in the background of a video may be modified to play an advertisement for a particular product, or a product like a Starbucks coffee cup may be placed on a table in the scene where contextually appropriate. Thus, a primary application of this invention alters one or more images in a video where human viewers would not perceive changes to the original video content. Notably, the subtle integration is particularly important for advertisers to ensure products are not associated with malformed content.

Typically, published digital video on the Internet is compressed, transferred, decompressed, and displayed on medium-resolution computer screens. These compression algorithms are designed to exclude similar image features not perceptible to a human eye to reduce the number of colors, shades, subtle lighting and texture changes. Therefore compressed video content will usually undergo further approximation to appear more like it is part of the original video. These perceptual factors must be accounted for in order to ensure video will be perceived as unaltered to viewers.

Preferably, in a first step of the method of the invention, a video segment, frame sequence, or image area to be modified is initially identified. Then precise coordinates in each frame are analyzed in greater detail to better define a region to be modified. Some “natural” markers are selected after the location to be modified is identified. Natural Markers are defined as items or objects already in the scene like, for example: windows, frames, tables, light sources, objects, indoor or outdoor scenery, cups, bottles, cutlery, computer equipment, TV screens, items hanging on walls, etc. Accordingly, these identified natural markers in the video enable more stable and accurate content alteration. The marker data and location information is stored for future use as a video requiring further content alteration would require less computer processing time for subsequent content changes. In other words, a database of marker data and location information is collected and stored.

The selected content area is projectively transformed to create an undistorted version of the background. Projectively Transformed (or projective transformation) is defined as creating a direct frontal view of the image without any distortion in terms of angle, shade, light, translucency, color gradient, or textural features—these features being referred to hereinafter as “Adjustment Features”, This undistorted copy of the texture preserving two-dimensional image region may be further filtered (for example via blurring) to purposely degrade fine texture details, as long as there is still preservation of general appearance and relative spatial positions of features. This stage can thus generate general dominant background image information like lighting and color gradients, but suppress finer details that would normally be lost in surface reflections.

When the content area is Projectively Transformed, the data on the Adjustment Features is recorded. This data is used later in this process when the image is eventually transformed back with modifications to the image to retain the characteristics of the target image so that the viewer does not to notice any post-production changes. Further details on this is provided below.

Accordingly, the new content undergoes weighted blending with the undistorted background region. This process involves adjusting the new content and the surrounding area in the image being modified, for previously calculated factors regarding the Adjustment Features. Adaptively camouflaging the object suppresses visual errors in appearance that would otherwise draw attention to the subtly modified content. Therefore, human perception is taken into account to calculate how the new image will better match the preexisting scene.

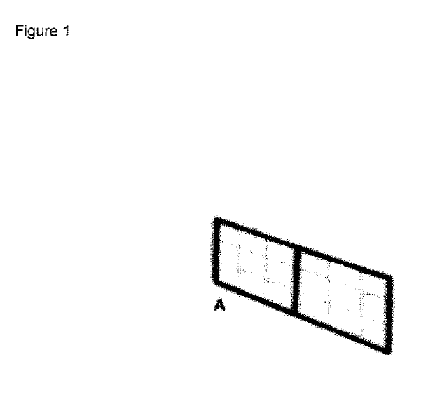

For example, a regular Gaussian image-blurring filter is applied to each pixel in an image, but does account for inferred 3D scene structure. Regular blurring methods usually produce two dimensional concentric circular areas across the entire image with a Gaussian distribution. Therefore, textures or patterns following a perspective surface would be degraded in a counterintuitive manner which can appear as visual aberrations to a human observer. This type of blur often preserves dominant features of a two dimensional picture, but will create a false notion of rapidly degrading finer image details (FIG. 1). In FIG. 1, the finer details such as thin lines are not preserved consistently across the surface, as traditional methods do not account for the scene structure.

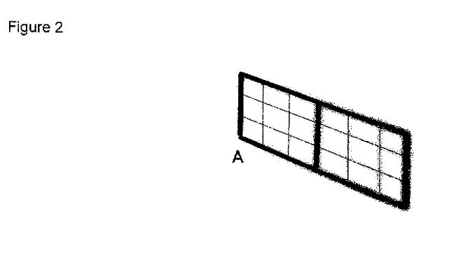

However, the method in this invention which includes three dimensional scene structure data ensures selected planes attributes like Depth-of-Field are visually preserved for the viewer. Additional graphical items are blended into the surface appear consistent with the planes appearance by incorporating similar patterns, perceived color, and lighting changes. Note the example in FIG. 2 preserves the dominant details further along an inferred surface that would otherwise be lost (FIG. 1).

The blended image may be further projectively transformationed to match the original scene perspective view where only blended regions with modified content are placed back into the original scene. Notably, an outline of these new areas is used to perform adaptive edge blending with existing unmodified content to remove abnormal object boundary transitions.

For example, when adding a Starbucks coffee cup to a table it is preferred to choose a clean area of the table away from the edge. This method enables the cup to appear stable to a human eye as surrounding areas form the optical illusion of simultaneous contrast if no other perceptual cues are present. Otherwise, if a cup was placed at the edge of the table than the object would appear to be somewhat shifting to human viewers. Likewise, small movements that “naturally” occur in digital video due to compression artifacts are not usually perceptible to human viewers, but the addition of the new objects may create a hybrid image of low-frequency components that suddenly change the viewer's perspective. Prior to the method of the invention, it would have been challenging to keep inserted items precisely positioned consistently due to the motion tears, visual aberrations, compression artifacts, and human visual biases.

It should be noted that the characteristics of the new content may have its own Adjustment Features which has to be accounted for when adding the new content. For example, if one is inserting a shiny object or an object with very bright colors into an image, then the surrounding area in the original image being modified would preferably at least partially reflect such new shade and color features while accounting for human perception factors, in order for the image not to look like it was modified post-production.

### Adjustment Factors—Colour and Continuity

In a further aspect of the invention any modifications/insertions to a video, there is provided a step to compare the color of the synthetic content (post production modified or otherwise newly added content) with that of the original scene or video. In one preferred embodiment, histograms are used to characterize color, luminosity, hue saturation, lightness and other image properties, and thereafter the synthetic content is adjusted to remain consistent with the scene. The adjustment level is variable depending on the distinctiveness of the item being placed in the scene (for example if the item being inserted in the frame(s) is statistically very dissimilar to the original video content, then the inserted item's properties are given higher weighting than the properties in the original scene). Therefore, the adjustment factors (adjusted color and lighting) are used to add weighted changes to the original artificial content in order to avoid rendering aberrations caused by abnormal color distributions in the target frame content.

This method also provides a means to adjust for abnormal distribution in frames within a scene where the rendered zone would be disproportionately filtered by the surrounding environments' biased color distributions. For example, an orange on a white cloth surface would bias its own color distribution as it is statistically dissimilar to the background under most lighting conditions. Thus, dissimilar objects may share similar lighting for consistent appearance, but artificially weight the rendered content's unique properties to remain visually distinctive as an orange.

In order for the viewer not to notice violations in continuity, any post production changes in the image modifications have to visually remain stable. This apparent stability can be impacted by, among other things:
Movement in the original video from frame to frame, multiple frames to multiple frames, or scene to scene
Relative movement of different items/objects in the original video. Such movement is relative since it can be caused by items moving in the scene or movement of the camera when the original video was taken. Since the results of a computer analysis will only show movement of one item versus another while a human viewer would intuitively know which item is stable while which is moving, especially in the context of camera movements
Video aberrations from distortion or noise in video properties.

The method of this invention identifies the transition frame or multiple frame location and the nature of the transition from one scene to another by:
a) identifying luminosity values/levels of pixels in a selected frame,
b) creating a histogram of luminosity for each frame, and
c) comparing changes in the average or weighted average of luminosity histograms over several frames with the current frame(s) under analysis.

This method allows multiple frame video scene transition sequences to be identified while reducing overall false identification rate. Additionally, monitoring the average rate change information can determine the type of transition in use within the footage, and can therefore be used to adapt content for fading-to/from-black, cross-fading footage, and rapid cuts. This method ensures that artificially rendered content will match the existing footage content properties even if editing transitions already exist within the footage. For example, when a TV show cuts to a commercial, it usually fades to black for the transition before starting on the commercial. This method would enable identification of such a transition. Another example of this would be to identify where a video instantly is cut from one location (like an office) to a different location (like a kitchen).

Such key frame markers also define the temporal boundaries for tracking an occurrence of a detected item forwards and or backwards through the time-line of scene frames.

In one aspect of this invention, feature detection methods (such as image corner detectors where two gradients from an orthogonal intersection) assist in segmenting objects or areas of a video/scene which are in relative motion compared to the background of the scene. Alternatively, these methods identify camera motion within the video sequences. Clusters of tracked sample points with similar characteristics (color, position, shading, luminosity, etc.) are used to determine locations of areas/items/objects in single or multiple frames. This data's persistent features are then converted into a motion histogram to extrapolate a refined estimate of stable components within a frame's structural layout. This method ensures motion of modified content is correctly synchronized with existing (or previously modified where a video goes through multiple stages of modification) content, which, in turn, virtually eliminates jitter from feature aberrations in frames. Additionally, this method correctly isolates synthetic content from overlapping occluding objects, and allows partial overlapping content to appear more cohesive.

The occluding objects within a sequence are tracked even if stationary for moments in time, and may be separated from the background even where there is general camera motion. For example, if new content is being added to a stable surface in a sequence, than the relative motion of the composited area will remain consistent with the scene's motion. However, the synthetic content will adapt to automatically remain in the background if an object like a human hand passes over the modified area, or the area itself partially moves out of the frame boundary edges. Thus, the modified areas appear more consistent with the existing content, and less likely to err in continuity for the rendered scene output.

This method of feature group motion tracking ensures that a modified scene remains structurally consistent, and can adapt object rendering techniques to avoid abnormal looking content. There are numerous situations which can arise with these techniques, but with key frame transition markers these methods handle rendering differently under different situations as shown below:
1) The first type is when object appearance is successfully identified for the entire video sequence between key frames. This method ensures seamless clip rendering with correct object position tracking, stabilization, and occlusion exclusion. For example, a detected object on a surface would determine the relative position and interval of appearance for accompanying artificial content.
2) The second type is when object appearance is identified at the beginning of the clip, but partially or fully disappears while the remaining or most of features of the scene continue. Under this method the last known object position would be tracked for the remainder of the scene. This method works if the tracked motion is relatively persistent, and modified areas do not cause the renderer to violate structural continuity. For example, an initially detected object would not only determine the last known position, but help extrapolate the necessary length of time background tracking must occur to add synthetic content in the area of the scene being modified.
3) The third type occurs when object appearance is identified partway into the clip, but must track backwards in the scene or the sequence of the frames from the initially identified object position toward the first known scene/frame sequence transition point in the time-line.
4) The fourth type occurs when object appearance is identified partway into the clip and ends at a transition point. However, it fails to track backwards from the initially identified object position toward a prior transition point in the scene or frame sequence. This usually indicates persistent occluding events occurred within this clip, and thus has an increased probability that false object detection or rapid rendering aberrations may occur. This method classifies such content as requiring additional filtering review and/or adjustment by post production or automated or manual editors.
5) The fifth type occurs when object appearance is initially identified at the start of a scene, but fails to track the initially identified object position partway into the scene/frame sequence. This usually indicates unstable and or occluded events occur within this clip, and more advanced scene analysis must be used through automated or manual editing to remove contradictory areas of modified content from the successive frames. Therefore objects passing in-front of the modified region would correctly infer the illusion of various video properties like color, luminosity, depth, shadows, etc.
6) The sixth type occurs when object appearance is identified partway into a scene frame sequence, but fails to track backwards from the initially identified object position toward a prior transition point in the scene/frame sequence. This strongly indicates occluding events occurred within this clip, and thus indicates false detections or rendering aberrations may be present. Under this invention, scene decomposition and segmentation techniques may be used through partial modified content behind occluding object regions.
7) No object of the specific type sought was identified in this scene, and the system notes such scenes of interest for additional analysis. Under this invention, some standard techniques may be used to compare prior accumulated knowledge of several frame sequences relatively stable backgrounds, form a hypothesis of similar looking scene backgrounds, and persist continuity by partially adding modified regions to the severely occluded content. This condition makes strong assumptions about persistent scene features, and may require review by post production editors.

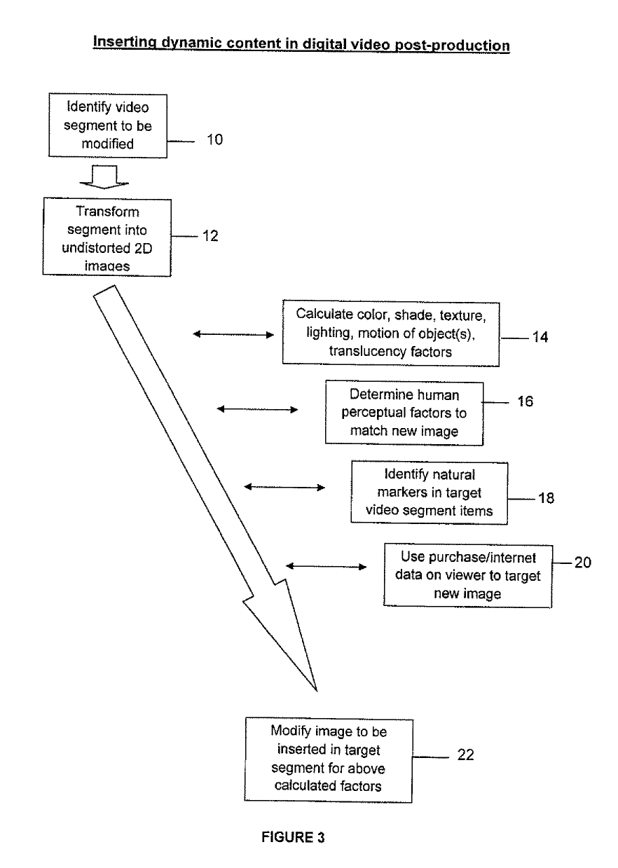

FIG. 3 is a flow chart showing the steps of modifying an image in a digital video file post-production. At 10, there is provided a first step of identifying a video segment to be modified. Said segment is transformed at 12 into one or more undistorted 2D images. At steps 14-18, the selected content area undergoes a projective transformation to create an undistorted version of the background using Adjustment Features. At step 20, other inputs such as user behaviours including user searching, purchasing and other data is factored to target a specific and preferred new, replacement or modified image. At step 22, the modified image is inserted into the media segment.

In an alternative embodiment of this invention the camera properties of a video may be obtained from the producer of such video and then used as input data to assist in image alteration. If the camera properties are unknown, than finding the relative size of objects in a scene can be challenging. For an inserted item to remain contextually consistent, this invention finds multiple “natural” markers in the scene to infer a scale for inserted objects. The camera angle and perceived depth are recovered from the area in which an object is to be placed. These “natural” markers would include common known items or objects whose size would generally be consistent like: human faces, hands, TV screens, soda cans, and other widely used products.

For example, the scale of a Starbucks coffee cup placed on a table could be set by finding local stable object markers like a soda can, person, or coffee cup. Thus, the approximate size of a Starbucks cup would be extrapolated for placement on the table, and an optical illusion of depth will usually make it appear normal to a viewer. To allow this illusion to occur it is crucial that the new object have no obvious depth cues present, and the background has dominant converging perspective lines. Typically, depth cues have visual attributes that bias an observer to perceive a malformed foreshortening illusion of a two dimensional object image, and are preventable by avoiding object image perspectives which include: product lid tops/openings, distorted orthogonal lines, contradictory pose angles, gaps/shadows, or odd lighting artifacts etc.

Notably, this invention would adapt to complement existing textures which have abnormal gradients that change along a single image in a video. For example, this type of scene would have a prominent table surface as part of the scene, but its textures appearance would alter by placing a reflective object like a shiny soda can, an image of a product with very strong colors, a Starbucks cup near its surface. In this invention these factors would be used to adapt how a new object is blended into the existing image. Accordingly, the new image would be altered to match such a gradient within preset limits of human perception of texture consistency.

In an alternative embodiment of this invention, all data relating to Adjustment Features, Projective Transformation and weighted Blending may be available from prior analysis of the subject video or obtained and/or determined when the video is produced. In such cases, the original video may be produced with prior knowledge of possible future image alteration.

In another embodiment of this invention, it may be desired that a new object placed in an image needs to be noticeable to a viewer in a specific way. In such a situation, the data on the Adjustment Features would be used to highlight the inserted image in predetermined manner to be subtly or more prominently noticeable. For example, if one is inserting a soda can in a scene but would like the can to be noticed by a viewer but not to appear as if it was inserted post-production, then one may insert an image of an open cold and dripping soda can with some vapor visible at its mouth. This would, using human perceptual factors, make the soda can noticeable to the consumer but will appear to have been done pre-production.

In an alternative embodiment of this invention, choosing which product to insert into a video scene could be targeted based on viewer demographics, data on purchase behavior and Internet usage data. For example, if a viewer is known to prefer Coke than a competitor may want to place a Pepsi soda can within an appropriate video scene location for advertising purposes. A competitor may also run a Pepsi advertising spot on a TV screen in the background of the video scene. In an alternative embodiment of this invention, any products or objects that are appearing in the original video could be removed from the video with the Adjustment Features being appropriately modified to ensure that the resulting background space is altered in a manner so that to a viewer the video does not appear to have been altered. In this embodiment a “manipulated image” is actually removed and replaced with a weighted blended background, based on adjustment features.

In an alternative embodiment of this invention, other content in a video (e.g. wall color, texture of tables, color of TV screen or other objects, floor color or texture, etc.) is altered for to have better impact on advertising of a product placed in such a video. Again the Adjustment Factors would be appropriately modified to ensure that such alterations are made so that the video does not appear to a viewer to have been altered.

Movies and TV programs are typically between 15-120 minutes in length. Therefore there are numerous placement opportunities for multiple products from numerous advertisers. In another embodiment of this invention, this can be used to create traceable unique content for every viewer receiving a different combination of advertising or generic objects placed within the video.

Within the scope of the invention, such traceable unique content for every viewer need not be advertising items. In fact, traceable items may, in certain aspects, be changes to very minor items in a video (items that are completely in the background and have no contextual relevance, such as, for example, cups; pens, pencils, paper clips and other stationery items; minor changes made to wall posters, pictures, rugs, carpets patterns, and other items normally placed on floors or hanging on walls; etc. For example, in a movie one could alter the colors of items that are originally in a movie such as, for example, cups, paperclips, change color of a minor items in a wall poster, ballpoint pens, books on bookshelves. In this example if each item can be one of several different colors, then the mathematical combination of numerous such items in several colors would easily enable distribution of a video to hundreds of millions of viewers with each copy of a video that is distributed (for example on Cable TV, NetFlix. Redbox, Amazon Instant Video, HULU, etc.) has a different color combination of these minor items which could be tracked by viewer to tag, for example, for copyright infringement and to identify copyright protected material. For example, if a viewer of a movie makes an unauthorized copy and distributes it widely, then the colors of such background items would indicate to the publisher the source of copyright infringement since a typical viewer would not be able to (without access to original data from the publisher about changes on video by each viewer) determine the items with such color alterations.

In other words, using the image manipulation method provided herein, internal “tags” are inserted to identify material which is copied without authorization. Furthermore, an original viewer could be easily identify if a copyright holder's rights were violated. This passive digital rights management system would be less invasive and easily readable by looking for the unique alterations in scenes. Therefore, the invention provides an effective method for both publishers to track and control copyright infringement incidents. This method would apply to online streaming, mobile distribution, distribution of physical dvd's or other such storage items in vending machine where the such identifying tags or copyright markers are recorded immediately prior to distribution, etc. Such identification tags or copyright markers could be inserted in video or the video modified for such items at the source computer or on the viewer's computer/device or any intermediate computer/device on the distribution network.

Current methods of copyright protection schemes are based on software that prevents copying or enables tracking. The existing methods of content control become ineffective due to escalations in technology that render current solutions ineffective, but under this invention the content becomes a subtle robust tracking technology. The advertisement or object placements are not generally perceptible to the human eye as being distinguishable from the background. Different viewers would receive different combinations of products or advertisements in every video downloaded. This uniqueness is can also be preserved if the same user downloads the same title again. However, all the markers would not be discernible to a potential copier of the video.

In an alternative embodiment, “manipulating” with respect to an image means adding, removing, or otherwise modifying an existing image wherein said image is an ancillary feature. It is preferred that the ancillary feature is selected from the group consisting of appliances, digital or media display devices, computer monitors, laptop computers, tablets, smartphones, electronic devices, walls, tables, floors, counters, televisions and furniture It is preferred, that data in respect to at least one of the adjustment features, projective transformation and weighted blending, is obtained and determined when an original video is produced with expected, predicted and projected image changes at downloading.

Within some aspects of the invention, it is preferred that adjustment features are acquired from original digital video creator.

It is preferred that the digital “video” file is streaming media.

It is preferred that the image replacement, removal, manipulation or addition steps are carried out by a computer displaying or conveying media file. It is also preferred that said steps are carried out by a server storing said digital video file. It is further preferred that said steps are carried out by a computer receiving said digital video file from a server and transmitting said digital video file to a second computer.

In a preferred form, part of the method of image replacement, removal, manipulation or addition is done before the video is uploaded by the original publisher of the video to a central computer library for distribution to numerous viewers and the remaining part of the process is done at the central computer prior to a viewer requesting downloading of such video for viewing.

It is preferred that a new image is substituted based on compensation paid to a provider of said digital video file.

It is further preferred that an image is a distinctive image and is used to determine a context associated with said digital video file. It is preferred that the method is carried out by a software program product. It is preferred that the method of image replacement, removal, manipulation or addition is based on a history of behavior(s) of a user, said user viewing a digital media file. These behaviours include, but are not limited to viewing and purchasing history of said user over the internet. One goal of “history” analysis is to determine patterns of usage and user preferences. This will enable user-specific and targeted image replacement, removal, manipulation or addition. For example, the image replacement, removal, manipulation or addition may be based on the Internet data of a user, said user viewing said digital video file. Viewing and purchasing history to acquire Internet data includes: any user data relating to emails, searching via search engines, and social media preferences.

In another aspect, the method of the present invention is used to identify multiple image placements by each viewer thereby to create traceable and unique content by viewer.

This can be used to easily identify the source of a video and to flag when copyright holders' rights are violated.

The invention further provides a system for placing virtual products within a moving media of motion picture or television content, comprising: an original moving media content source including a removable content, the removable content providing a virtual product location at a position in the moving media; a network in communication with the original moving media content source, the network providing a virtual product source; and a virtual product disposed within the virtual product source, the virtual product being an image of an item enabled for placement in the virtual product location of the removable content, the virtual product being enabled for updating the position of the virtual product location of the removable content in the moving media, wherein the virtual product is downloaded from the network, and placed on the moving media in the virtual product location; and wherein the virtual product is updated on the moving media in the virtual product location, by means of the following steps:
a) projectively transforming a segment of the moving media from a first state to a second state, the second state being one which defines a substantially undistorted background, primed for new product insertion, and wherein any feature differences as between the first state and the second state are adjustment features;
b) recording data related to the adjustment features;
c) selecting a point of insertion of new product; and
d) blending the new product with the second state of the segment of the moving media, weighing the adjustment features against each such that any visual cues which would mark placement of the new product as incongruous are adjusted.

As will be apparent to those skilled in the art, the various embodiments described above can be combined to provide further embodiments. Aspects of the present systems, methods and components can be modified, if necessary, to employ systems, methods, components and concepts to provide yet further embodiments of the invention. For example, the various methods described above may omit some acts, include other acts, and/or execute acts in a different order than set out in the illustrated embodiments.

Further, in the methods taught herein, the various acts may be performed in a different order than that illustrated and described. Additionally, the methods can omit some acts, and/or employ additional acts.

These and other changes can be made to the present systems, methods and articles in light of the above description. In general, in the following claims, the terms used should not be construed to limit the invention to the specific embodiments disclosed in the specification and the claims, but should be construed to include all possible embodiments along with the full scope of equivalents to which such claims are entitled. Accordingly, the invention is not limited by the disclosure, but instead its scope is to be determined entirely by the following claims.

### III. Computing

Further and in addition to the disclosure provided above, it will be readily apparent to one of ordinary skill in the art that the various processes and methods described herein may be implemented by, e.g., appropriately programmed general purpose computers, special purpose computers and computing devices. Typically a processor (e.g., one or more microprocessors, one or more microcontrollers, one or more digital signal processors) will receive instructions (e.g., from a memory or like device), and execute those instructions, thereby performing one or more processes defined by those instructions. Instructions may be embodied in, e.g., a computer program.

A “processor” means one or more microprocessors, central processing units (CPUs), computing devices, microcontrollers, digital signal processors, or like devices or any combination thereof.

Thus a description of a process is likewise a description of an apparatus for performing the process. The apparatus that performs the process can include, e.g., a processor and those input devices and output devices that are appropriate to perform the process.

Further, programs that implement such methods (as well as other types of data) may be stored and transmitted using a variety of media (e.g., computer readable media) in a number of manners. In some embodiments, hard-wired circuitry or custom hardware may be used in place of, or in combination with, some or all of the software instructions that can implement the processes of various embodiments. Thus, various combinations of hardware and software may be used instead of software only.

The term “computer-readable medium” refers to any medium, a plurality of the same, or a combination of different media that participate in providing data (e.g., instructions, data structures) which may be read by a computer, a processor or a like device. Such a medium may take many forms, including but not limited to, non-volatile media, volatile media, and transmission media. Non-volatile media include, for example, optical or magnetic disks and other persistent memory. Volatile media include dynamic random access memory (DRAM), which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read.

Various forms of computer readable media may be involved in carrying data (e.g. sequences of instructions) to a processor. For example, data may be (i) delivered from RAM to a processor; (ii) carried over a wireless transmission medium; (iii) formatted and/or transmitted according to numerous formats, standards or protocols, such as Ethernet (or IEEE 802.3), SAP, ATP, Bluetooth™, and TCP/IP, TDMA, CDMA, and 3G; and/or (iv) encrypted to ensure privacy or prevent fraud in any of a variety of ways well known in the art.

Thus a description of a process is likewise a description of a computer-readable medium storing a program for performing the process. The computer-readable medium can store (in any appropriate format) those program elements which are appropriate to perform the method.

Just as the description of various steps in a process does not indicate that all the described steps are required, embodiments of an apparatus include a computer/computing device operable to perform some (but not necessarily all) of the described process.

Likewise, just as the description of various steps in a process does not indicate that all the described steps are required, embodiments of a computer-readable medium storing a program or data structure include a computer-readable medium storing a program that, when executed, can cause a processor to perform some (but not necessarily all) of the described process.

Where databases are described, it will be understood by one of ordinary skill in the art that (i) alternative database structures to those described may be readily employed, and (ii) other memory structures besides databases may be readily employed. Any illustrations or descriptions of any sample databases presented herein are illustrative arrangements for stored representations of information. Any number of other arrangements may be employed besides those suggested by, e.g., tables illustrated in drawings or elsewhere. Similarly, any illustrated entries of the databases represent exemplary information only; one of ordinary skill in the art will understand that the number and content of the entries can be different from those described herein. Further, despite any depiction of the databases as tables, other formats (including relational databases, object-based models and/or distributed databases) could be used to store and manipulate the data types described herein. Likewise, object methods or behaviors of a database can be used to implement various processes, such as the described herein. In addition, the databases may, in a known manner, be stored locally or remotely from a device which accesses data in such a database.

Various embodiments can be configured to work in a network environment including a computer that is in communication (e.g., via a communications network) with one or more devices. The computer may communicate with the devices directly or indirectly, via any wired or wireless medium (e.g. the Internet, LAN, WAN or Ethernet, Token Ring, a telephone line, a cable line, a radio channel, an optical communications line, commercial on-line service providers, bulletin board systems, a satellite communications link, a combination of any of the above). Each of the devices may themselves comprise computers or other computing devices, such as those based on the Intel® Pentium® or Centrino™ processor, that are adapted to communicate with the computer. Any number and type of devices may be in communication with the computer.

In an embodiment, a server computer or centralized authority may not be necessary or desirable. For example, the present invention may, in an embodiment, be practiced on one or more devices without a central authority. In such an embodiment, any functions described herein as performed by the server computer or data described as stored on the server computer may instead be performed by or stored on one or more such devices.

Where a process is described, in an embodiment the process may operate without any user intervention. In another embodiment, the process includes some human intervention (e.g., a step is performed by or with the assistance of a human).

As will be apparent to those skilled in the art, the various embodiments described above can be combined to provide further embodiments. Aspects of the present systems, methods and components can be modified, if necessary, to employ systems, methods, components and concepts to provide yet further embodiments of the invention. For example, the various methods described above may omit some acts, include other acts, and/or execute acts in a different order than set out in the illustrated embodiments.

The present methods, systems and articles also may be implemented as a computer program product that comprises a computer program mechanism embedded in a computer readable storage medium. For instance, the computer program product could contain program modules. These program modules may be stored on CD-ROM, DVD, magnetic disk storage product, flash media or any other computer readable data or program storage product. The software modules in the computer program product may also be distributed electronically, via the Internet or otherwise, by transmission of a data signal (in which the software modules are embedded) such as embodied in a carrier wave.

For instance, the foregoing detailed description has set forth various embodiments of the devices and/or processes via the use of examples. Insofar as such examples contain one or more functions and/or operations, it will be understood by those skilled in the art that each function and/or operation within such examples can be implemented, individually and/or collectively, by a wide range of hardware, software, firmware, or virtually any combination thereof. In one embodiment, the present subject matter may be implemented via ASICs. However, those skilled in the art will recognize that the embodiments disclosed herein, in whole or in part, can be equivalently implemented in standard integrated circuits, as one or more computer programs running on one or more computers (e.g., as one or more programs running on one or more computer systems), as one or more programs running on one or more controllers (e.g., microcontrollers) as one or more programs running on one or more processors (e.g., microprocessors), as firmware, or as virtually any combination thereof, and that designing the circuitry and/or writing the code for the software and or firmware would be well within the skill of one of ordinary skill in the art in light of this disclosure.

In addition, those skilled in the art will appreciate that the mechanisms taught herein are capable of being distributed as a program product in a variety of forms, and that an illustrative embodiment applies equally regardless of the particular type of signal bearing media used to actually carry out the distribution. Examples of signal bearing media include, but are not limited to, the following: recordable type media such as floppy disks, hard disk drives, CD ROMs, digital tape, flash drives and computer memory; and transmission type media such as digital and analog communication links using TDM or IP based communication links (e.g., packet links).

### Example 1

### Steps for Video Alteration

1. Identify a video segment (one or more frame in a digital video, 3D video, 2D plus depth video, or in digital pictures) and the image area to be modified.
2. Select scene/frame sequence to be analyzed for change in video properties to identify relative motion of objects and background in scene/frame sequence.
3. Select image area to create stable modified content that adjusts for occluding items, item or background movement, etc.
4. Conduct Projective Transformation to create an undistorted image.
5. Record the data on the adjustment features.
6. Perform additional projective transformation back to the original content location perspective, and conduct weighted blending of inserted image into target video.
7. Adjust image for human perceptual factors to make altered video look like any changes were made pre-production (not post production).
8. Prepare modified content for delivery to viewer.

### Example 2

1. Adjust target video image to make the placed product/image be noticeable to a viewer without it appearing like the video has been altered (e.g. the Coke bottle is open and dripping with vapor appearing from the mouth of the bottle because it is cold, or a bag or Doritos lying flat on a table with chips coming out).
2. Remove a product or one that conflicts with a product placed in a video.
3. Substitute a product in a video.
4. Adjust video image to add/change other content besides adding/removing or substituting a product (e.g. change wall, table and/or floor color to enhance impact of placed product).
5. Obtain camera properties from original video producer (rather than derive it from the target video).
6. Obtain all data on adjustment features, projective transformation and weighted blending and determine when original video produced with expected, predicted and projected image changes at downloading.
7. Use viewer's internet data and/or purchase data to target advertising, product placement and other image changes.
8. Use multiple image placements by each viewer to create traceable and unique content by viewer to easily identify source of video when copyright holders' rights are violated.

1. A method of inserting a new image into a dynamic digital video file, the method comprising:
a) identifying a target digital video segment;
b) projectively transforming the digital video segment from a first state to a second state, the second state defining a substantially undistorted background; primed for new image insertion, and defining adjustment features comprising any feature differences between the first state and the second state;
c) recording data related to the adjustment features;
d) selecting a point of insertion of the new image; and
e) blending the new image with the second state of the target digital video segment, weighing the adjustment features to adjust visual cues which would mark placement of the new images as incongruous.

2. A method of manipulating an existing image into a digital video file, the method comprising:
a) identifying a target digital video segment comprising an existing image;
b) projectively transforming the digital video segment from a first state to a second state, the second state defining a substantially undistorted background, primed for image manipulation, and defining adjustment features comprising feature differences between the first state and the second state;
c) recording data related to the adjustment features;
d) selecting a point of manipulation of the existing image; and
e) blending a manipulated image with the existing image, weighing the adjustment features to adjust visual cues which would mark placement of the new images as incongruous.

3. The method of claim 2 wherein manipulating comprises removing the existing image.

4. The method of claim 2 wherein blending comprises weighted blending of the adjustment features by important to draw a viewer's eye away from differences between the manipulated image and the background.

5. The method of claim 2 wherein the undistorted background is undistorted in respect to at least one of the following features: colour, shade, lighting, luminosity, hue saturation and texture

6. The method of claim 2 wherein the undistorted background is undistorted in relation to lighting, angles, shading, translucency, colour gradients and textural features.

7. The method of claim 1 wherein the new image replaces an existing conflicting image.

8. The method of claim 1 wherein the new image is a weighted blended background based on adjustment features.

9. The method of claim 3 wherein the existing image is an ancillary feature.

10. (canceled)

11. The method of claim 2 wherein data in respect to least one of the adjustment features, projective transformation and blending and weighing the adjustment features are determined when the digital video file is produced with predicted image changes.

12. The method of claim 2 wherein adjustment features are acquired from a creator of the digital video file.

13-18. (canceled)

19. The method of claim 1 wherein a distinctive image is used to determine a context associated with said digital video file.

20-22. (canceled)

23. The method of claim 2 wherein the manipulated image comprises traceable unique content.

24-29. (canceled)

30. A method of inserting a new image into a digital video file, the method comprising:
a. identifying a segment of the video file for insertion of the new image and identifying an image area to be modified;
b. selecting and analyzing a scene/frame sequence for any change in video properties thereby identifying relative motion of one or more objects and background in the scene/frame sequence;
c. selecting an image area to create stable modified content;
d. adjusting for at least one of occluding items, item movement and background movement;
e. conducting at least one projective transformation to create an undistorted image;
f. recording data on the relative motion and background;
g. conducting weighted blending of the new image into the segment of video;
h. using one or more of the relative motion and background, adjusting the new image for human perceptual factors to make an altered video appear that changes were made preproduction.

31. The method of claim 1 wherein the new image comprises a copyright infringement marker.

32. The method of claim 2 wherein the manipulated image comprises a copyright infringement marker.

33. The method of claim 1 wherein the background is undistorted in respect to one or more of the following features: colour, shade, lighting, luminosity, hue saturation and texture and wherein the features are identified and characterized by histograms.

34. The method of claim 1 wherein the new image comprises traceable unique content.

35. The method of claim 15 wherein the new image comprises a copyright infringement marker.

36. The method of claim 2 wherein the background is undistorted in respect to one or more of the following features: colour, shade, lighting, luminosity, hue saturation and texture, and wherein the features are identified and characterized by histograms.

37. A digital video file comprising a plurality of minor items appearing in one or more segments of the digital video, each of the plurality of minor items in the background of the digital video; wherein the color of each of the minor items has been manipulated, weighing adjustment features of at least one of the segments, to create a unique colour combination for a recipient of the digital video file to thereby track the digital video file.
